(19) United States
(12) Patent Application Publication
(10) Pub. No.: US 2002/0165672 A1
(43) Pub. Date: Nov. 7, 2002

(54) System, method and article of manufacture to facilitate remote well head data collection, analysis and report generation

(76) Inventor: Charles H. Newman JR., Ft. Smith, AR (US)

Correspondence Address: HEAD, JOHNSON & KACHIGIAN, 228 W 17TH PLACE, TULSA, OK, 74119, US

(21) Appl. No.: 10/138,976

(22) Filed: May 3, 2002

Related U.S. Application Data
(60) Provisional application No. 60/288,607, filed on May 4, 2001.

(51) Int. Cl. G06F 19/00

(52) U.S. Cl. 702/14

(57) ABSTRACT

The invention is directed towards an improved system, process and article of manufacture to facilitate remote site well head data collection, remote client analysis and report generation based upon client specified criteria. In the invention's preferred embodiment, well related data is first determined and entered into a field site general purpose computer, such as but not limited to, a small transportable general purpose type computer. First field site software means executing within the field site general purpose computer adapts the computer to accept, store and process said entered well related data. Once stored within the field site computer, the data is uploaded, accepted by and stored within an access facilitation database. In turn, the access facilitation database is communicably attached to a general purpose computer which, utilizing intermediate data software means, has been adapted to serve as web server computer. The adapted web server computer makes a web page available to a client community via a communication link, such as the Internet, whereupon a client computer accesses the web page and via a selection of one or more dialog options, retrieves data originally uploaded to the facilitation database. Clients accessing said web page are presented via said intermediate data software means a number of processing options including but not limited to client access validation, report selection, report creation, export of information and administrative functions.

### REFERENCE TO PENDING APPLICATIONS

This application claims the benefit of U.S. Provisional Application No. 60/288,607, filed May 4, 2001, and incorporated by reference herein in its entirety.

### REFERENCE TO MICROFICHE APPENDIX

This application is not referenced in any microfiche appendix.

### TECHNICAL FIELD OF INVENTION

The present invention relates generally to automated data processing systems. In particular, the present invention is directed to a system, method and article of manufacture to facilitate remote site oil and/or natural gas well head data collection, client analysis and report generation based upon specified client criteria.

### BACKGROUND OF THE INVENTION

Today field personnel collect information daily from geographically dispersed oil and/or natural gas well site locations including numerous readings from a variety of equipment located at the well site. These readings include among others wellhead pressures, gas sale volumes, compressor, dehydrator, plunger lift, well test and tank readings for both oil and water. Indeed, in some instances 80 or more different readings must be made and recorded. The contemporary art finds field personnel interpreting readings from well site equipment and scribbling information from each well site to paper. Before the information can be utilized, it must then be copied again onto Company Gauge Sheets or other types of forms. Gauge sheets typically consist of seven carbon sheets and are typically distributed weekly or monthly to specified offices. After the field data has been received from field personnel, this data is once again “copied” or entered into some type of database or either digital record format by an office clerk. This lengthy process must be repeated on a daily basis to meet production requirements for certain wells. Only after this lengthy process, can the data be fully viewed, printed and analyzed by other personnel. Consequently, the present means of reading, interpreting, storing, copying and utilizing well related data represents an inefficient, labor intensive and time consuming process. Deficiencies to which the instant invention addresses itself.

The instant invention enhances the art and addresses the above noted deficiencies by presenting an improved system, process and article of manufacture to facilitate remote site well head data collection, remote client analysis and report generation based upon client specified criteria. In the invention's preferred embodiment, well related data is first determined and entered into a field site general purpose computer, such as but not limited to, a small transportable general purpose type computer. First field site software means executing within said field site general purpose computer adapts the computer to accept, store and process said entered well related data. Once stored within the field site computer, the data is uploaded, accepted by and stored within an access facilitation database. In turn, the access facilitation database is communicably attached to a general purpose computer which, utilizing intermediate data software means, has been adapted to serve as web server computer. The adapted web server computer makes a web page available to a client community via a communication link, such as the Internet, whereupon a client computer accesses the web page and via a selection of one or more dialog options, retrieves data originally uploaded to the facilitation database now accessible via the web server. Clients accessing said web page are presented via said intermediate data software means a number of processing options including but not limited to client validation, report selection, report creation, export of information and administrative functions.

An object of the present invention, intended to overcome deficiencies in prior art systems, is to provide a system and method by which information relating to the current well head operational status and statistical information can be made available to a remotely located client community in a timely manner.

Another object of the instant invention is to provide the means by which timely information related to well head operation and performance characteristics can be collected in the field at the well site and uploaded to be made available to a remote site client community.

A further object of the instant invention is to eliminate the redundant copying of well head related information prior to client reference and utilization.

Yet another object of the instant invention is to reduce or eliminate likelihood of error when re-copying well site related information prior to said information's use.

A further object of the instant invention is to provide a remote site user friendly computer based dialog for field personnel required to read and store well related information at disparate and geographically dispersed well locations.

Another object of the instant invention is to provide a computer based user friendly dialog whereby a remote site client may be provided access to well related information.

Yet another object of the instant invention is to provide a computer based client dialog whereby said client may generate a multiplicity of reports utilizing remote site well related information.

Other objects and further scope of the applicability of the present invention will become apparent from the detailed description to follow, taken in conjunction with the accompanying drawings wherein like parts are designated by like reference numerals.

### BRIEF SUMMARY OF THE INVENTION

The invention is directed towards an improved system, process and article of manufacture to facilitate remote site well head data collection, remote client analysis and report generation based upon client specified criteria. In the invention's preferred embodiment, well related data is first determined and entered into a field site general purpose computer, such as but not limited to, a small transportable general purpose type computer. First field site software means executing within said field site general purpose computer adapts the computer to accept, store and process said entered well related data. Once stored within the field site computer, the data is uploaded, accepted by and stored within an access facilitation database. In turn, the access facilitation database is communicably attached to a general purpose computer which, utilizing intermediate data software means, has been adapted to serve as web server computer. The adapted web server computer makes a web page available to a client community via a communication link, such as the Internet, whereupon a client computer accesses the web page and via a selection of one or more dialog options, retrieves data originally uploaded to the facilitation database now accessible via the web server. Clients accessing said web page are presented via said intermediate data software means a number of processing options including but not limited to client validation, report selection, report creation, export of information and administrative functions.

The instant invention replaces the paper based field operations of the present art with an easily transportable personal computer capable of executing a Windows CE3, or similarly capable operating system. The easily transportable computer executes field site software means under the dispatching control of its operating system, and provides field site personnel with a graphical interface, touch screen entry and drop down menus to collect, record and store well related data. Said data is then transferred over the Internet or other similarly intended computer compatible communications network via a phone line or cellular connection to a secured web server. Once the data has been transferred, it is processed and made available over the “World Wide Web” within a matter of minutes to a plurality of remotely located clients. Cold Fusion™ software or other similarly purposed software is used to enable the data to be viewed as an Internet web page, accessible to any computer connection. In contrast to today's paper based, manually communicated, error prone methodology, field garnered data point can be marketed, graphed, printed, exported, analyzed, e-mailed and viewed by all necessary personnel in a matter of minutes verses days.

Responsive to the foregoing challenges, Applicants have developed an innovative computer based system and method to facilitate remote site well head data collection, client analysis and report generation based upon specified client criteria comprising at least one field site general purpose computer comprising a central processing unit and at least one video display unit and at least one input device communicably attached to said central processing unit, said video display and input device configured to facilitate client interaction with said field site general purpose computer; at least one access facilitation database in communication with said field site computer, video display and input device, said database permitting said client to interactively specify and store said client criteria; field site software means which executes within and adapts said field site computer to accept well head data conditioned upon criteria specified by a client and to communicate said accepted well head data to said access facilitation database; at least one web server computer communicably attached to said access facilitation database; intermediate data software means executing within and adapting said web server computer to access and store data retrieved from said access facilitation database; at least one client general purpose computer communicably attached to said access facilitation general purpose computer; and a computer compatible network communication means capable of facilitating bi-directional transmission of digitized information between at least two general purpose computers of said system.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

In this respect, before explaining at least one embodiment of the invention in detail, it is to be understood that the invention is not limited in this application to the details of construction and to the arrangement so the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore that the claims be regarded as including such equivalent constructions insofar as they do not depart from the spirit and scope of the present invention.

Further, the purpose of the foregoing abstract is to enable the U.S. Patent and Trademark Office and the public generally, and especially the design engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Additional objects and advantages of the invention are set forth, in part, in the description which follows and, in part, will be apparent to one of ordinary skill in the art from the description and/or from the practice of the invention.

These together with other objects of the invention, along with the various features of novelty which characterize the invention, are pointed out with particularity in the claims annexed to and forming a part ofthis disclosure. For a better understanding of the invention, its operating advantages and the specific objects attained by its uses, reference would be had to the accompanying drawings, depictions and descriptive matter in which there is illustrated preferred embodiments and results of the invention.

### DESCRIPTION OF THE DRAWINGS

FIG. 1 is a system schematic providing a conceptual overview of functional elements of the instant invention as practiced in its preferred embodiment.

FIG. 2 is a system schematic illustrating processing logic flow of the invention's intermediate software means when practiced in its preferred embodiment.

FIG. 3 is a system schematic illustrating additional processing logic flow of the invention's intermediate software means when practiced in its preferred embodiment.

### DETAILED DESCRIPTION OF THE PREFERRED EMBODIMENT

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and the specification describe the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

While the invention has been described with a certain degree of particularity, it is clear that many changes may be made in the details of construction and the arrangement of components without departing from the spirit and scope ofthis disclosure. It is understood that the invention is not limited to the embodiments set forth herein for purposes of exemplification, but is to be limited only by the scope of the attached claim or claims, including the full range of equivalency to which each element thereof is entitled.

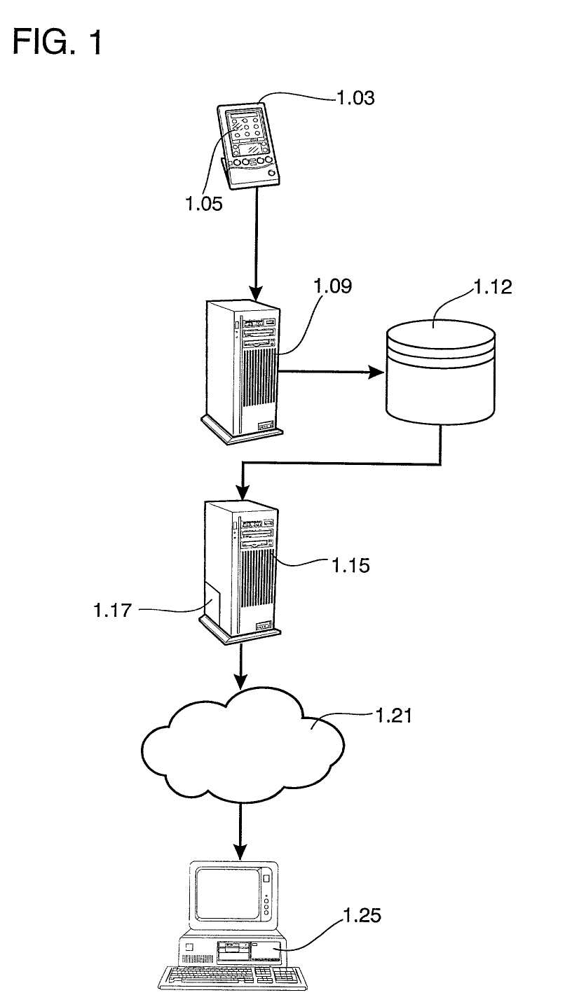

Referring to the drawings in detail, FIG. 1 is a system schematic providing a conceptual overview of the functional elements of the instant invention as practiced in its preferred embodiment. As can be seen in FIG. 1, a field site general purpose computer 1.03 is communicably attached to a database server 1.09, such as but not limited to an NT server or its equivalent which in turn is communicably attached to an access facilitation database 1.12. As used herein the term “NT” is used synonymously to refer to Windows NT™ or other similarly functioning 32-bit operating system that supports multi tasking. Said database 1.12 as practiced in the invention's preferred embodiment is an SQL (a.k.a. “Structured Query Language”) database, however as will be appreciated by those skilled in the art the invention is not limited to processing constraints limited to SQL processing. In an easily envisioned alternative embodiment, persons reasonably skilled in the art could adapt an alternative database management system and fourth generation query language program supporting such an alternative system. The present invention contemplates such alternative database management systems including but not limited to relational, flat and hierarchical organizations of information supported by said database management systems (a.k.a. “DBMS”). The access facilitation database 1.12 is in turn communicably attached to a web server 1.15. Field site software means 1.05 residing and executing within the field site general purpose computer 1.03 adapts said general purpose computer 1.03 to a special purpose computer which is thus enabled to first accept client specified criteria determining remote site well data to be uploaded and stored to said database 1.12 and made accessible to said client computer 1.25. Intermediate data software means 1.17 executing within said web server computer 1.15 adapts said web server computer to accept and provide for a dialog between a client desiring to access said database 1.12 via said client computer 1.25. Said intermediate software means 1.17 allows the client via a computer compatible communications link, such as but not limited to wide area networks (WANS), campus area networks (CANS), metropolitan area networks (MANS), local area networks (LANS), or the Internet 1.21, 20 to select information and processing service options made available to it via said adapted web server computer 1.15. Without limitation, such options include a process grouping including client validation, report creation, report execution, data export and administrative functions.

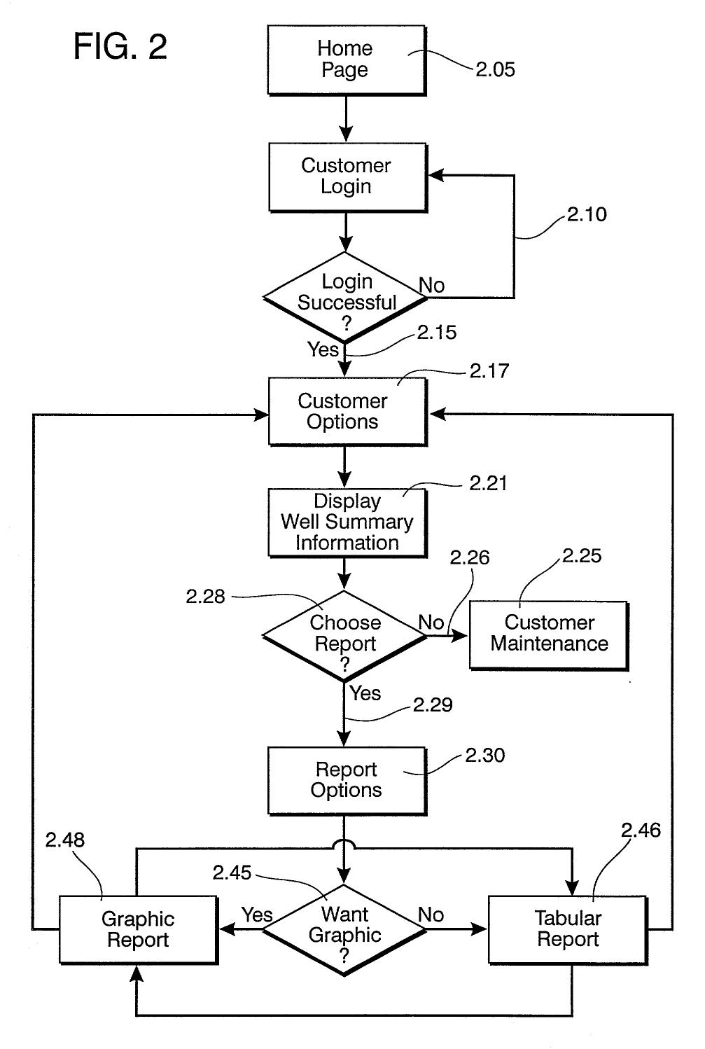

FIG. 2 provides further detail with respect to client processing options once connected and having gained access to the invention's intermediate software processing means 1.17. Turning now to FIG. 2.

FIG. 2 further illustrates a system schematic illustrating processing logic flow of the invention's intermediate software means when practiced in its preferred embodiment. In FIG. 2 a client accesses the home page 2.05 of the instant invention and through which access to uploaded well head data is first facilitated. A client or customer is first introduced via the home page 2.05 to a client logon verification sequence 2.10. During this sequence the client is asked to provide identifying information, and once such information has been provided and validated, the client is logged in to the system 2.15 and presented with a number of client processing options 2.17. In a non-limiting exemplary scenario, the identified and validated client is presented with well information gathered at the well site and previously uploaded to a communicably attached database for observation 2.21. The client is asked if he wishes to generate a report 2.28 using the previously uploaded well information. Should the client elect not to chose report processing 2.26, the client is passed to a client maintenance processing option 2.25 whereupon individualized maintenance activity may be initiated. Assuming the client has affirmed that he wishes to generate a report 2.29, a further report menu is provided 2.30 and the client is specifically requested to identify the type and name of the report to be produced utilizing database stored and accessible well summary information 2.21. In selecting report options 2.30 a further processing option is provided to the client in terms of graphic 2.48 or tabular report representation 2.46. If a graphic report selection is affirmed 2.48, a report is generated and the client is returned to the client options menu 2.17. If a tabular report 2.46 is so affirmed by the client, a tabular report is generated with the control then passed back to the client for additional client option selection 2.17.

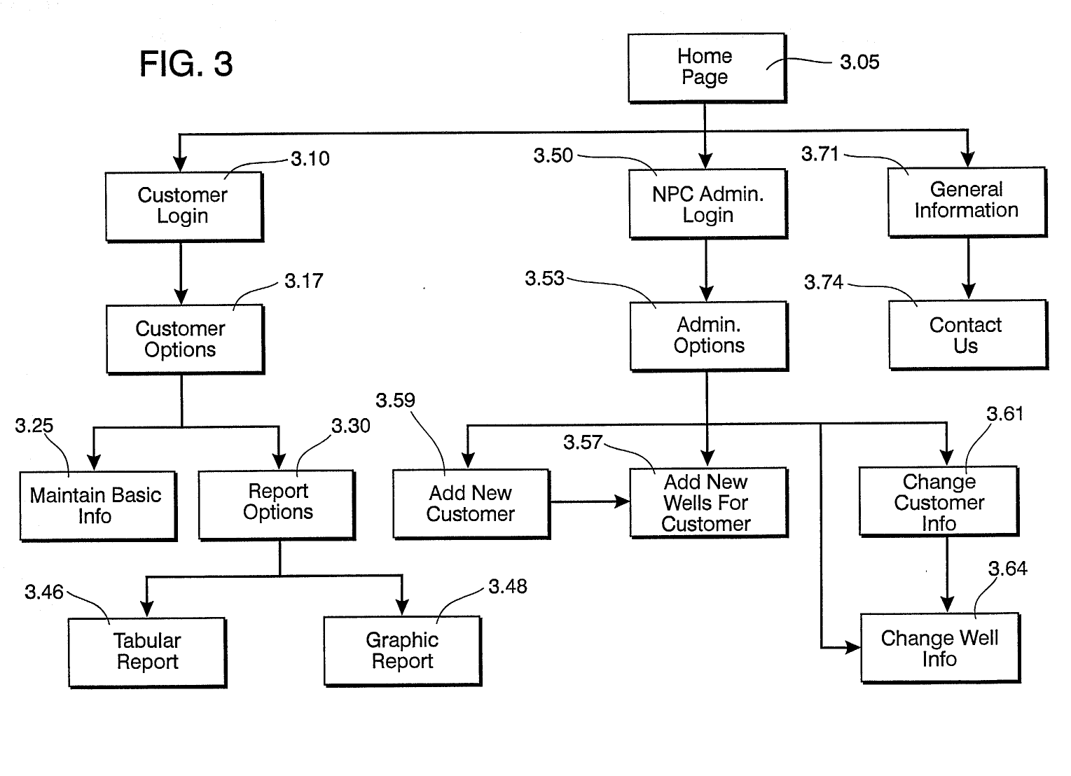

FIG. 3 further illustrates a system schematic illustrating additional processing logic flow components of the invention's intermediate software mean when practiced in its preferred embodiment. Turning now to FIG. 3.

In FIG. 3, an administrator enters a sign on validation routine 3.50 with successful validation introducing the administrator to a number of administrative options 3.53. As can be seen in FIG. 3, administrative processing options include but are not limited to adding new wells for a specific client 3.57, adding a new client 3.59, modifying client information 3.61 or modifying previously stored well information 3.64. Additional processing capability as practiced by the invention in its preferred embodiment include without limitation the providing of general information to the public 3.71 including but not limited to information relating to where additional information may be sought relative to the invention's functionality and/or capabilities 3.74.

While this invention has been described to illustrative embodiments, this description is not to be construed in a limiting sense. Various modifications and combinations of the illustrative embodiments as well as other embodiments will be apparent to those skilled in the art upon referencing this disclosure. It is therefore intended that this disclosure encompass any such modifications or embodiments.

Having thus described the invention, what is claimed and desired to secure Letter of Patent is:

1. A computer based system to facilitate remote site well head data collection, client analysis and report generation based upon specified client criteria comprising:
at least one field site general purpose computer comprising a central processing unit and at least one video display unit and at least one input device communicably attached to said central processing unit, said video display and input device configured to facilitate client interaction with said field site general purpose computer;
at least one access facilitation database in communication with said field site computer, video display and input device, said database permitting said client to interactively specify and store said client criteria;
field site software means which executes within and adapts said field site computer to accept well head data conditioned upon criteria specified by a client and to communicate said accepted well head data to said access facilitation database;
at least one web server computer communicably attached to said access facilitation database;
intermediate data software means executing within and adapting said web server computer to access and store data retrieved from said access facilitation database;
at least one client general purpose computer communicably attached to said access facilitation general purpose computer; and
a computer compatible network communication means capable of facilitating bi-directional transmission of digitized information between at least two general purpose computers of said system.

2. The system as recited in claim 1 wherein said general purpose computer, said video display, said input device and said database are communicably attached via a computer compatible communications network.

3. The system as recited in claim 1 where said system further comprises the facilitation of multiple and essentially simultaneous client access and viewing data stored upon said access facilitation database.

4. The system as recited in claim 1 wherein said input device is a computer keyboard or a computer mouse and said video display is a computer monitor.

5. A computer based method to facilitate remote site well head data collection, client analysis and report generation based upon specified client criteria comprising:
(a) determining the scope and content of well related data to be entered into and stored within a field site general purpose computer;
(b) executing field site software means accessible to, and adapting said field site general purpose computer to accept said determined well related data;
(c) entering said determined well related data according to data entry menu options presented to said client via said adapted field site computer; and,
(d) uploading aid entered well related data to an access facilitation database communicably attached to said adapted field site computer.

6. The method of claim 5 wherein said entered data entry menu option is selected from a menu option grouping including:
(a) well head;
(b) meter;
(c) data;
(d) water tank;
(e) oil tank;
(f) compressor data;
(g) compressor engine;
(h) pumping unit;
(i) dehydrator data; and
(i) plunger lift.

7. The method of claim 5 wherein said uploading of entered well data to an access facilitation database further comprises the synchronization of said transferred well data with data presently residing within said database.

8. The method of claim 5 further comprising making said synchronized data accessible to a plurality of well data clients via a web server communicably attached to said access facilitation database.

9. The method of claim 5 further comprising at least one well data client accesses said uploaded data via a communications dialogue between said client and a well data home page hosted by said web server.

10. The method of claim 9 further comprising wherein said communications dialogue allows said client to select information and processing services among to a process grouping including:
(a) client validation;
(b) report creation;
(c) report execution;
(d) data export; and
(e) administrative functions.
